(19) United States
(12) Patent Application Publication
(10) Pub. No.: US 2012/0057704 A1
(43) Pub. Date: Mar. 8, 2012

(54) System and Method for Providing Security in a Wireless Communications System

(75) Inventor: Bin Chen, Schaumburg, IL (US)

(73) Assignee: FutureWei Technologies, Inc., Plano, TX (US)

(21) Appl. No.: 13/086,085

(22) Filed: Apr. 13, 2011

Related U.S. Application Data
(60) Provisional application No. 61/380,620, filed on Sep. 7, 2010.

(51) Int. Cl. H04L 9/00

(52) U.S. Cl. 380/270

(57) ABSTRACT

A system and method for providing security in a wireless communications system are provided. A method for device operations includes generating a security key from an initial key, producing secured information by applying the security key to radio resource allocation information, and transmitting the secured information to the communications device. The radio resource allocation information comprises a location of radio resource allocated to a communications device.

This application claims the benefit of U.S. Provisional Application No. 61/380,620, filed on Sep. 7, 2010, entitled “Method to Improve Radio Resource Allocation,” which application is hereby incorporated herein by reference.

### TECHNICAL FIELD

The present invention relates generally to digital communications, and more particularly to a system and method for providing security in a wireless communications system.

### BACKGROUND

Wireless broadband access systems have changed the way that their users work and enjoy information access. No longer are users of wireless broadband access systems restricted to specific locations with wireline access to information services. In fact, users are free to move wherever they like within a coverage area and still have rapid access to information that they need and/or desire.

Most wireless broadband access systems, notably WiMAX (based on a series of IEEE 802.16 technical standards), Wideband Code Division Multiple Access (WCDMA), High Speed Downlink Packet Access (HSDPA), Long Term Evolution (LTE) and LTE-Advanced (based on technical standards from The Third Generation Partnership Project (3GPP)), and so forth, feature a security function in the air interface to protect traffic and messages. Usually, encryption of some form is used to ensure integrity. Typically, the security function is provided at a Media Access Control (MAC) layer or higher. Unfortunately, for Physical (PHY) layer signaling, for example, radio resource allocation signaling, there is normally no protection.

As an example, in WiMAX (i.e., IEEE 802.16m) radio resource allocation signaling occurs over an allocation map (A-MAP), while in 3GPP LTE radio resource allocation signaling occurs over a physical downlink control channel (PDCCH) and in HSDPA it occurs over a high speed shared control channel (HS-SCCH). The signaling of the radio resource allocation to users (also commonly referred to as mobile stations, users, terminals, and so forth) occurs without encryption, so the information may be detected by unauthorized users. The unauthorized users may then know the location (e.g., time-frequency locations) of the radio resources and intercept transmissions made over the radio resources, thereby compromising the integrity of the communications.

### SUMMARY OF THE INVENTION

These and other problems are generally solved or circumvented, and technical advantages are generally achieved, by example embodiments of the present invention which provide a system and method for providing security in a wireless communications system.

In accordance with an example embodiment of the present invention, a method for device operations is provided. The method includes generating a security key from an initial key. The method also includes producing secured information by applying the security key to radio resource allocation information. The radio resource allocation information comprises a location of radio resource allocated to a communications device. The method further includes transmitting the secured information to the communications device.

In accordance with another example embodiment of the present invention, a method for device operations is provided. The method includes determining an initial key, and generating a security key from the initial key. The method also includes receiving secured information, and producing radio resource allocation information from the secured information by applying the security key to the secured information. The radio resource allocation information includes a location of radio resource allocated to a communications device. The method further includes detecting for a transmission at network resources specified by the radio resource allocation information.

In accordance with another example embodiment of the present invention, a communications controller includes a key generator, a radio resource allocate unit, an encryption unit coupled to the key generator and to the radio resource allocate unit, and a transmitter coupled to the encryption unit. The key generator generates a security key from an initial key, the radio resource allocate unit allocates a radio resource to a communications device, thereby producing radio resource allocation information, the encryption unit applies the security key to the radio resource allocation information, and the transmitter transmits the encrypted radio resource allocation information to the communications device.

One advantage disclosed herein is that by securing the resource allocation, an unauthorized user's probability of intercepting transmissions may be much lower; and, the integrity of communications may be preserved.

A further advantage of exemplary embodiments is that the use of a relatively short initial key, which may be exchanged between communications device, to generate a longer encryption key can reduce signaling overhead compared to exchanging a relatively long initial key.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1a illustrates an example communications system according to example embodiments described herein;

FIG. 1b illustrates an example communications system wherein a transmission occurs over allocated radio resources according to example embodiments described herein;

FIG. 2a illustrates an example flow diagram of operations in securing radio resource allocation information at a base station, which may be a source of the radio resource allocation information according to example embodiments described herein;

FIG. 2b illustrates an example flow diagram of operations in securing radio resource allocation information at a destination of the radio resource allocation information according to example embodiments described herein;

FIG. 3a illustrates an example flow diagram of operations in securing radio resource allocation information at a base station using a key as securing information according to example embodiments described herein;

FIG. 3b illustrates an example flow diagram of operations in securing radio resource allocation information at a mobile station using a key as securing information according to example embodiments described herein;

FIG. 4a illustrates an example encryption circuitry according to example embodiments described herein;

FIG. 4b illustrates an example decryption circuitry according to example embodiments described herein;

FIG. 5 illustrates an example PRBS generator according to example embodiments described herein;

FIG. 6 provides an example communications device according to example embodiments described herein; and

FIG. 7 provides an example communications device according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a WiMAX compliant communications system that signals resource allocations using an A-MAP. The invention may also be applied, however, to other communications systems that signal resource allocations, such as 3GPP WCDMA/HSDPA, 3GPP LTE, 3GPP LTE-Advanced, and so forth.

Generally, radio resource allocation signaling comprises a transmission of two pieces of data: a first part is the radio resource allocation information (which may include a radio resource index, a MIMO indicator, hybrid automatic repeat requested (HARM) information, and so forth); and a second part is an error check, such as a cyclic redundancy check (CRC) that may be used to check whether the radio resource allocation information signaling was received correctly.

In 3GPP HSDPA, a radio resource allocation information signaling scheme that is similar to that used in WiMAX is used. A Node B (also commonly referred to as a controller, a base station, an enhanced Node B, and so forth) uses a common channel referred to as the HS-SCCH to broadcast radio resource allocation information to User Equipment (UE), also commonly referred to as mobile station, user, terminal, subscriber, and so on, in the form of the radio resource allocation information and a CRC masked with a HSDPA radio network temporary identity (H-RNTI). When the UE receives the radio resource allocation information in the HS-SCCH, the UE may calculate the CRC with its own H-RNTI. If the CRC computed from the UE's H-RNTI produces a correct error check, then the UE received the radio resource allocation information that is intended for it.

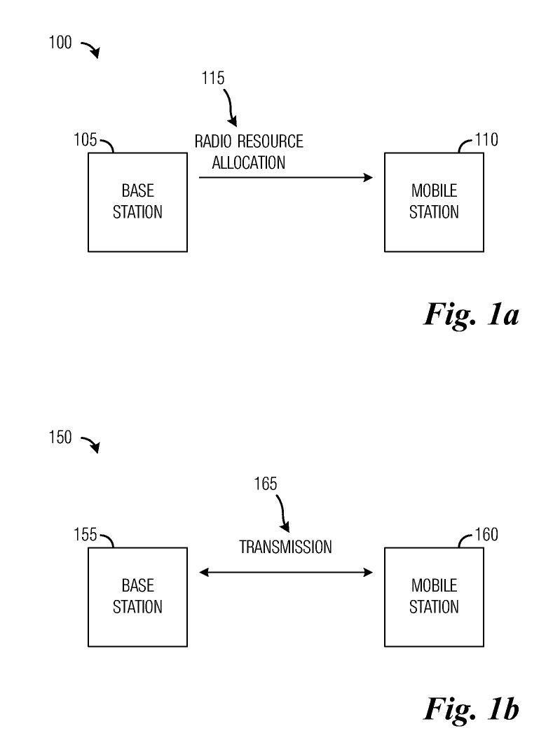

FIG. 1a illustrates a communications system 100. Communications system 100 includes a base station 105 (also commonly referred to as a controller, a communications controller, a NodeB, an enhanced NodeB, and so on) and a mobile station 110 (also commonly referred to as a mobile, a subscriber, a user, a terminal, a User Equipment, and so forth).

Base station 105 may control communications to and from mobile station 110 by allocating radio resource to mobile station 110. When base station 105 grants radio resources to mobile station 110 to transmit to mobile station 110 or to allow mobile station 110 to transmit, base station 105 informs mobile station 110 of the radio resource allocation through signaling or messaging 115 information regarding the radio resource allocation.

FIG. 1b illustrates a communications system 150 wherein a transmission occurs over allocated radio resources. Depending on the radio resource allocation, a base station 155 may transmit to a mobile station 160 or mobile station 160 may transmit to base station 155 (shown as transmission 165).

As discussed previously, radio resource allocation information is signaled to mobile stations without securing the information, which may allow an eavesdropper to intercept the radio resource allocation information, and potentially compromise the security of communications of the mobile stations since the eavesdropper knows where and/or when to listen in on transmissions to and/or from the mobile stations.

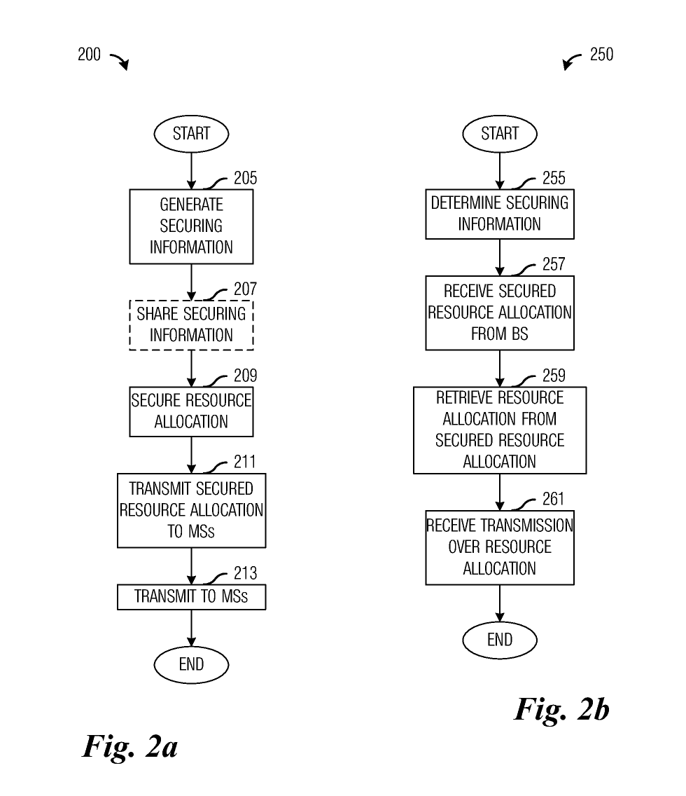

FIG. 2a illustrates a flow diagram of operations 200 in securing radio resource allocation information at a base station, which may be a source of the radio resource allocation information. Operations 200 may be indicative of operations occurring in the base station that is the source of the radio resource allocation information as the base station provides the radio resource allocation information to mobile stations served by the base station. Operations 200 may occur while the base station is in a normal operating mode and has mobile stations to serve.

Operations 200 may begin with the base station generating securing information (block 205). According to an example embodiment, the base station may generate securing information that may be used to secure the radio resource allocation information for each mobile station. The securing information may be unique for each mobile station. According to an alternative example embodiment, the securing information may be unique for a group (or class, type, or so forth) of mobile stations, and if there are multiple groups of mobile stations, then the base station may generate unique securing information for each group (or class, type, or so forth). According to an alternative example embodiment, the securing information may be unique for the mobile stations served by the base station.

Examples of securing information may include: mapping rule(s) used to map resources, such as those used to map downlink resource mapping in a WiMAX compliant communications system; separate signaling channel(s); encryption key(s); hashing function(s); mapping function(s); mapping table(s); permutation rule(s); permutation function(s); translation rule(s); translation function(s); re-calculation rule(s); re-calculation function(s); and so forth.

According to an example embodiment, the base station may make use of unique identifying information for the mobile station, mobile station group, mobile station class, mobile station type, itself, or a combination thereof, to generate the securing information. As an example, if the base station is generating securing information for each mobile station, then the base station may use information, such as the mobile station's identification number, for example, to generate the securing information. Preferably, the base station will make use of information that is unique for the mobile station and will remain constant for the mobile station while the base station continues to serve the mobile station.

The base station may then optionally share the securing information on the mobile station(s) (block 207). According to an example embodiment, the securing information may be transmitted to the mobile stations served by the base station. The securing information for each mobile station may be sent to the mobile station in a unique transmission. As an example, the securing information may be generated by the base station for the mobile station as the mobile station attaches to the base station during an initial startup procedure, a handover, or so forth.

According to an example embodiment, instead of sharing the securing information, the base station may share information related to the securing information, information that corresponds to the securing information, a portion of the securing information, or combinations thereof, with the mobile station.

According to an example embodiment, the securing information may be transmitted to the mobile station in a high layer message, such as a MAC layer message, using securing techniques (e.g., encryption) that may be built into high layer messages. The use of high layer messaging may provide a way to ensure that the securing information arrives at the mobile station with low probability of being intercepted by unauthorized users.

According to an example embodiment, a function used in generating the securing information may be known by the mobile station. Therefore, the mobile station may be capable of generating securing information that matches (or corresponds) to the securing information generated by the base station. Hence, the base station may not need to share the securing information with the mobile station.

The base station may then make its radio resource allocations, thereby generating the radio resource allocation information. The base station may then secure the radio resource allocation information using the securing information (block 209). According to an example embodiment, the base station may secure radio resource allocation information for a specific mobile station by applying or otherwise using securing information for the mobile station. According to an example embodiment, the base station may secure radio resource allocation information for the mobile stations served by the base station by applying the securing information for the mobile station with a function or algorithm.

As an example, the securing information may be applied using a mathematical function, an encryption algorithm, a mapping function, a transformation, a selection algorithm, or so on.

The base station may then send the secured radio resource allocation information to the mobile stations (block 211). According to an example embodiment, the secured radio resource allocation information may be broadcast to the mobile stations. As an example, the secured radio resource allocation information in a WiMAX compliant communications system may be broadcast to the mobile stations over an A-MAP; while in a 3GPP HSDPA compliant communications system, a HS-SCCH may be used to broadcast the secured radio resource allocation information; and in a 3GPP LTE and/or LTE-Advanced compliant communications system, a PDCCH may be used to broadcast the secured radio resource allocation information. According to an example embodiment, the base station may transmit the secured radio resource allocation information to individual mobile stations (or groups, types, or classes of mobile stations depending on a granularity of the securing information) in separate transmissions.

The base station may then transmit to the mobile station(s) at the allocated radio resources (block 213).

FIG. 2b illustrates a flow diagram of operations 250 in securing radio resource allocation information at a destination of the radio resource allocation information. Operations 250 may be indicative of operations occurring in the mobile station that is receiving radio resource allocation information from a base station that is serving the mobile station. Operations 250 may occur while the mobile station is in a normal operating mode and is being served by the base station.

Operations 250 may begin with the mobile station determining securing information that may be necessary to extract radio resource allocation information from secured radio resource allocation information sent by the base station (block 255). According to an example embodiment, the mobile station may receive the securing information, an indication of the securing information, a function of the securing information, a secured version of the securing information, or a combination thereof, from the base station.

According to an example embodiment, the mobile station may be capable of computing the securing information by itself based on a known function matching (or corresponding to) the one used by the base station to generate the securing information and unique information related to the mobile station instead of receiving the securing information from the base station. For example, the known function used by the base station may be indicated to the mobile station during initial startup, handover, or so on, with the base station and the mobile station may then generate the securing information using the known function.

The mobile station may then receive the secured radio resource allocation information from the base station (block 257). According to an example embodiment, the mobile station may receive the secured radio resource allocation information from a broadcast message from the base station. According to an example embodiment, the mobile station may receive the secured radio resource allocation information in a message from the base station that is specifically transmitted to the mobile station.

The mobile station may then retrieve the radio resource allocation information from the secured radio resource allocation information using the securing information that it either received from the base station or computed on its own (block 259). According to an example embodiment, the mobile station may make use of mapping rule(s) used to map resources; separate signaling channel(s); encryption key(s); hashing function(s); mapping function(s); mapping table(s); permutation rule(s); permutation function(s); translation rule(s); translation function(s); re-calculation rule(s); re-calculation function(s); and so forth, to retrieve the radio resource allocation.

Using the radio resource allocation information, the mobile station may then receive a transmission(s) from the base station at the radio resource(s) specified in the radio resource allocation information (block 261).

According to an example embodiment, an encryption key may be used in conjunction with an encryption function to secure the radio resource allocation information. The following description discusses several illustrative embodiments that make use of an encryption key and an encryption function to secure the radio resource allocation information.

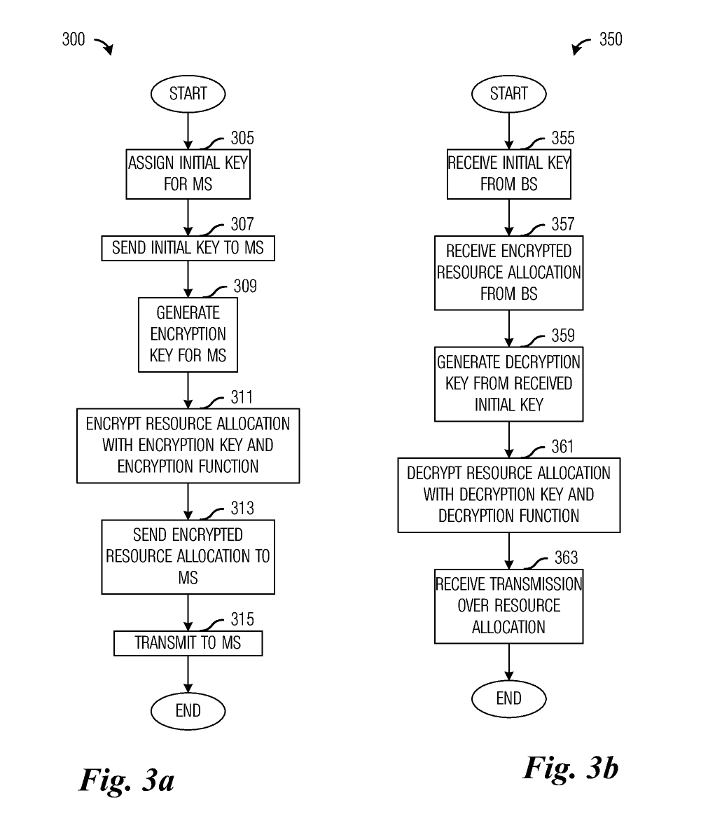

FIG. 3a illustrates a flow diagram of operations 300 in securing radio resource allocation information at a base station using a key as securing information. Operations 300 may be indicative of operations occurring in the base station that is the source of the radio resource allocation information as the base station provides the radio resource allocation information to mobile stations served by the base station. Operations 300 may occur while the base station is in a normal operating mode and has mobile stations to serve.

Operations 300 may begin with the base station assigning an initial key for mobile stations (block 305). According to an example embodiment, a unique initial key may be assigned to each mobile station served by the base station. According to another example embodiment, a unique initial key may be assigned to each group, type, or class of mobile station served by the base station.

According to an example embodiment, the initial key may be a binary sequence that is N bits long, wherein N is an integer value greater than or equal to one, with larger values of N being preferred since longer keys tend to provide superior security.

The initial key may then be sent to the mobile station (block 307). As discussed previously, the initial key may be sent to the mobile station using a high layer message that may include some form of security to help ensure that the key is not available to unauthorized users.

The base station may then use the initial key to generate an encryption key (block 309). According to an example embodiment, the encryption key may be used to secure the radio resource allocation information. According to an example embodiment, the encryption key may also be unique to the mobile station to which the initial key is assigned. According to an example embodiment, the encryption key may be unique to a group, type, or class of mobile station as the initial key.

According to an example embodiment, a transformation function is used to generate the encryption key from the initial key. As an example, a pseudo-random binary sequence (PRBS) generator may be used to generate the encryption key from the initial key, with the initial key being provided to the PRBS generator as an input sequence and the encryption key being provided by the PRBS generator as an output sequence. According to an example embodiment, the PRBS generator includes a sequence of memory cells with at least as many memory cells as bits in the initial key. As another example, a shift register may be used to generate the encryption key form the initial key.

According to an example embodiment, other transformation functions, such as concatenations, randomizations, permutations, and so forth, may be used to generate the encryption key from the initial key. In general, any transformation function may be used to generate the encryption key from the initial key as long as the transformation function preserves the uniqueness properties of the initial key in the encryption key.

According to an example embodiment, the initial key may be relatively short when compared to the encryption key. A relatively short initial key may be preferred since the initial key may be transmitted to the mobile station, resulting in less overhead when compared to a relatively long initial key.

An example of generating the encryption key from the initial key may be as follows: Let the initial key be 10101010, the encryption key may be generated from copied and expanded versions of the initial key and may be 1010101010101010101010101010101010101010. Alternatively, the encryption key is generated from copied and reversed versions of the initial key and may be 0000111100001111000011110000111100001111.

The base station may then use the encryption key to encrypt the radio resource allocation information (block 311). According to an example embodiment, a wide range of encryption functions may be used to encrypt the radio resource allocation information using the key. For example, a binary function, such as a bitwise binary exclusive-OR (XOR) operation, may be used to encrypt the radio resource allocation information. If the radio resource allocation information is longer than the encryption key, then the encryption key may be used to repeatedly encrypt different portions of the radio resource allocation information, while if the radio resource allocation information is shorter than the encryption key, then the radio resource allocation information may be padded until it is of equal length to the encryption key.

For discussion purposes, consider an IEEE 802.16m or IEEE 802.16e compliant communications system, wherein the radio resource allocation information is signaled in an A-MAP, which may be 56 bits long (40 bits radio resource allocation information and 16 bits Cyclic Redundancy Check (CRC)). Assuming that the encryption key is also 40 bits long, the base station may mask the radio resource allocation information with the encryption key using a binary function, such as a binary XOR function.

Instead of a bitwise XOR operation, other operations that provide reversible transformations using the key may be used. Furthermore, in addition to relatively simple logical operations, more complex key-based encryption algorithms may be used, such as Master Session KEY (MSK), Pairwise Master Key (PMK), Authentication Key (AK), Traffic Encryption Key (TEK), Cipher-based Message Authentication Code (CMAC Key), and so forth, algorithms.

The base station may then send the encrypted radio resource allocation information to the mobile station (block 313). According to an example embodiment, if the base station is also allocation radio resources for other mobile stations, the base station may also transmit encrypted radio resource allocation information to the other mobile stations.

The base station may subsequently transmit to the mobile station when the radio resource(s) allocated to the mobile station appear (block 315).

FIG. 3b illustrates a flow diagram of operations 350 in securing radio resource allocation information at a mobile station using a key as securing information. Operations 350 may be indicative of operations occurring in the mobile station that is receiving radio resource allocation information from a base station that is serving the mobile station. Operations 350 may occur while the mobile station is in a normal operating mode and is served by the base station.

Operations 350 may begin with the mobile station receiving an initial key from the base station serving the mobile station (block 355). As discussed previously, the initial key may be sent to the mobile station using a high layer message that may include some form of security to help ensure that the key is not available to unauthorized users. According to an example embodiment, a unique initial key may be assigned to each mobile station served by the base station. According to another example embodiment, a unique initial key may be assigned to each group, type, or class of mobile station served by the base station.

According to an example embodiment, instead of receiving the initial key from the base station, the mobile station may be able to generate its own version of the initial key. The mobile station may generate the initial key from information consistent with the information used by the base station to generate the initial key, therefore, ensuring that the initial key at the mobile station is either the same as the initial key at the base station or corresponds to the initial key at the base station. According to an example embodiment, the mobile station may make use of algorithms such as Master Session KEY (MSK), Pairwise Master Key (PMK), Authentication Key (AK), Traffic Encryption Key (TEK), Cipher-based Message Authentication Code (CMAC Key), and so forth, to generate the initial key.

The mobile station may then receive encrypted radio resource allocation information from the base station (block 357). According to an example embodiment, the encrypted radio resource allocation information may be encrypted using an encryption key, which may be generated from the initial key (the base station's version of the initial key).

From the initial key, the mobile station may generate a decryption key (block 359). According to an example embodiment, a transformation function is used to generate the decryption key from the initial key. As an example, a pseudo-random binary sequence (PRBS) generator may be used to generate the decryption key from the initial key, with the initial key being provided to the PRBS generator as an input sequence and the decryption key being provided by the PRBS generator as an output sequence. The PRBS generator used to generate the decryption key for the mobile station may or may not be the same as the PRBS generator used to generate the encryption key for the base station.

According to an example embodiment, other transformation functions, such as concatenations, randomizations, permutations, and so forth, may be used to generate the decryption key from the initial key. In general, any transformation function may be used to generate the decryption key from the initial key as long as the transformation function preserves the uniqueness properties of the initial key in the decryption key.

According to an example embodiment, the decryption key may be the same as the encryption key used by the base station. According to another example embodiment, the decryption key may correspond to the encryption key used by the base station.

The mobile station may then use the decryption key to decrypt the encrypted radio resource allocation information (block 361). According to an example embodiment, a wide range of decryption functions may be used to decrypt the encrypted radio resource allocation information using the key. For example, a binary function, such as a bitwise binary exclusive-OR (XOR) operation, may be used to decrypt the encrypted radio resource allocation information. If the encrypted radio resource allocation information is longer than the decryption key, then the decryption key may be used to repeatedly decrypt different portions of the encrypted radio resource allocation information, while if the encrypted radio resource allocation information is shorter than the decryption key, then the encrypted radio resource allocation information may be padded until it is of equal length to the decryption key.

After obtaining the radio resource allocation information, the mobile station may detect for transmissions at the radio resource(s) specified in the radio resource allocation information to receive transmission(s) from the base station (block 363).

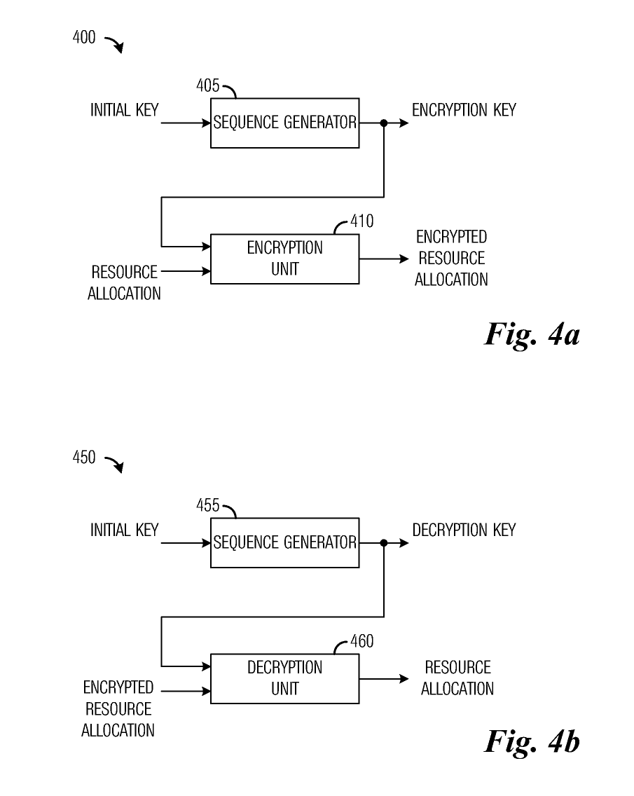

FIG. 4a illustrates encryption circuitry 400. Encryption circuitry 400 may be representative of encryption circuitry in a base station that uses encryption circuitry 400 to secure radio resource allocation information prior to transmitting the radio resource allocation information to mobile stations served by the base station.

Encryption circuitry 400 includes a sequence generator 405 to generate an encryption key from an initial key. According to an example embodiment, sequence generator 405 may implement a transformation function, or other functions, such as, concatenations, randomizations, permutations, and so forth, to generate the encryption key from the initial key. As an example, sequence generator 405 may be a PRBS generator.

The encryption key may be provided to an encryption unit 410, which may use the encryption key to encrypt the radio resource allocation information. According to an example embodiment, encryption unit 410 may make use of a binary function, such as a bitwise binary exclusive-OR (XOR) operation, or key-based encryption algorithms, such as Master Session KEY (MSK), Pairwise Master Key (PMK), Authentication Key (AK), Traffic Encryption Key (TEK), Cipher-based Message Authentication Code (CMAC Key), and so forth, algorithms to encrypt the radio resource allocation information using the encryption key.

FIG. 4b illustrates decryption circuitry 450. Decryption circuitry 450 may be representative of decryption circuitry in a mobile station that uses decryption circuitry 450 to decrypt encrypted radio resource allocation information received a base station serving the mobile station.

Decryption circuitry 450 includes a sequence generator 455 to generate an encryption key from an initial key. According to an example embodiment, sequence generator 455 may implement a transformation function, or other functions, such as, concatenations, randomizations, permutations, and so forth, to generate the decryption key from the initial key. As an example, sequence generator 455 may be a PRBS generator.

The decryption key may be provided to a decryption unit 460, which may use the decryption key to decrypt the encrypted radio resource allocation information. According to an example embodiment, decryption unit 410 may make use of a binary function, such as a bitwise binary exclusive-OR (XOR) operation, or key-based encryption algorithms, such as Master Session KEY (MSK), Pairwise Master Key (PMK), Authentication Key (AK), Traffic Encryption Key (TEK), Cipher-based Message Authentication Code (CMAC Key), and so forth, algorithms to decrypt the radio resource allocation information using the decryption key.

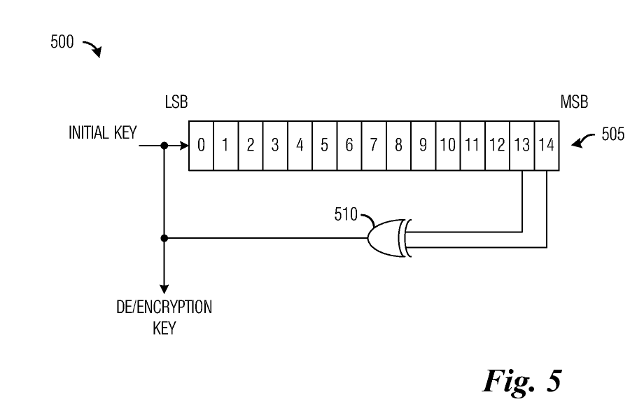

FIG. 5 illustrates a PRBS generator 500. PRBS generator 500 may be an implementation of sequence generator 405 and/or sequence generator 455 of encryption circuitry 400 and decryption circuitry 450, respectively. PRBS generator 500 includes a sequence of memory cells 505 arranged in serial fashion (in other words, sequence of memory cells 505 may be sequentially arranged), numbered from 0 to N-1, wherein N is a length of an initial key input into sequence of memory cells 505.

The initial key may be shifted into sequence of memory cells 505 one value (bit) at a time, therefore, it may take a total of N shifts before the initial key is entirely in sequence of memory cells 505. According to an example embodiment, the initial key may be shifted into sequence of memory cells 505 from most significant bit (MSB) to least significant bit (LSB) order.

PRBS generator 500 also includes logical circuitry 510, for example, a bitwise logical XOR, with inputs coupled to one or more memory cells in sequence of memory cells 505. As an example, logical circuitry 510 may have two inputs with a first input coupled to an N-th memory cell and a second input coupled to a N-1-st memory cell. Although the discussion focuses on a bitwise logical XOR with inputs coupled to the N-th and N-1-st memory cells, other logical circuits with different numbers of inputs and input configurations may be used. Therefore, the discussion of the bitwise logical XOR with inputs coupled to the N-th and N-1-st memory cells should not be construed as being limiting to either the scope or the spirit of the embodiments.

Output of logical circuitry 510 may be used as an encryption key if PRBS generator 500 is used in an encryption circuit on a decryption key if PRBS generator 500 is used in a decryption circuit. Output of logical circuitry 510 is also coupled back into sequence of memory cells 505.

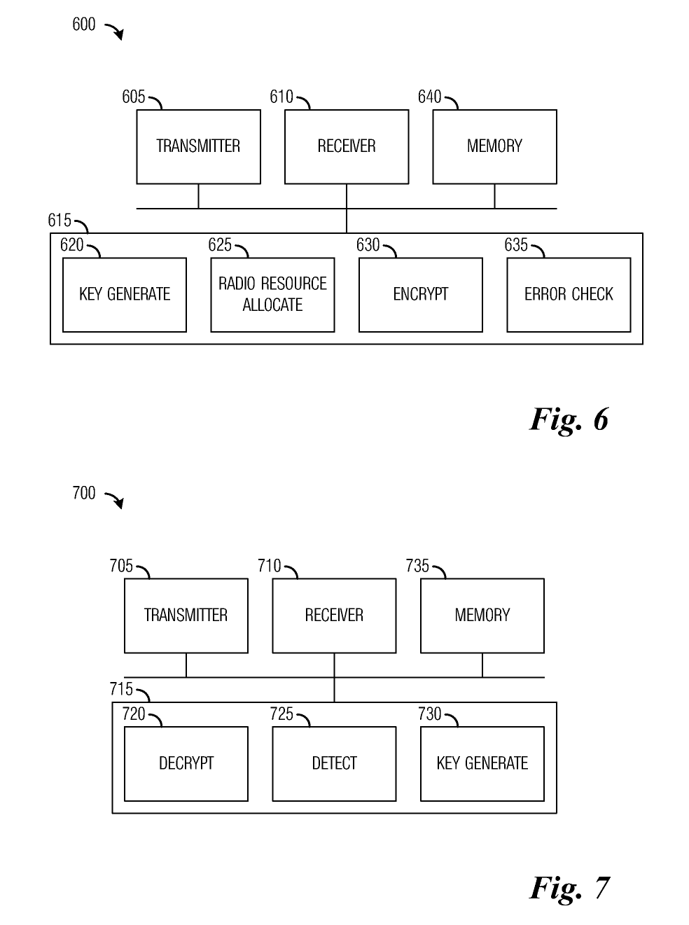

FIG. 6 provides an alternate illustration of a communications device 600. Communications device 600 may be an implementation of a base station. Communications device 600 may be used to implement various ones of the embodiments discussed herein. As shown in FIG. 6, a transmitter 605 is configured to transmit information and a receiver 610 is configured to receive information. A key generate unit 620 is configured to generate keys, such as an initial key, and an encryption and/or decryption key. A radio resource allocate unit 625 is configured to allocate radio resource(s) to a mobile station. An encrypt unit 630 is configured to secure radio resource allocation information using the keys. An error check unit 635 is configured to generate error checking information. A memory 640 is configured to store information, keys, as well as messages, and so on.

The elements of communications device 600 may be implemented as specific hardware logic blocks. In an alternative, the elements of communications device 600 may be implemented as software executing in a processor, controller, application specific integrated circuit, or so on. In yet another alternative, the elements of communications device 600 may be implemented as a combination of software and/or hardware.

As an example, receiver 610 and transmitter 605 may be implemented as a specific hardware block, while key generate unit 620, radio resource allocate unit 625, encrypt unit 630, error check unit 635, may be software modules executing in a microprocessor (such as processor 615) or a custom circuit or a custom compiled logic array of a field programmable logic array.

FIG. 7 provides an alternate illustration of a communications device 700. Communications device 700 may be an implementation of a mobile station. Communications device 700 may be used to implement various ones of the embodiments discussed herein. As shown in FIG. 7, a transmitter 705 is configured to transmit information and a receiver 710 is configured to receive information. A decrypt unit 720 is configured to use keys received from a base station and/or generated by communications device 700 to extract radio resource allocation information from secured radio resource allocation information, a detect unit 725 is configured to detect transmissions at radio resources specified in the radio resource allocation information, and a key generate unit 730 is configured to generate an initial key, and an encryption and/or decryption key. A memory 735 is configured to store information, keys, as well as messages, and so on.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 710 and transmitter 705 may be implemented as a specific hardware block, while decrypt unit 720, detect unit 725, and key generate unit 730 may be software modules executing in a microprocessor (such as processor 715) or a custom circuit or a custom compiled logic array of a field programmable logic array.

The above described embodiments of communications device 600 and communications device 700 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 2a, 2b, 3a, and 3b—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for device operations, the method comprising:
generating a security key from an initial key;
producing secured information by applying the security key to radio resource allocation information, wherein the radio resource allocation information comprises a location of radio resource allocated to a communications device; and
transmitting the secured information to the communications device.

2. The method of claim 1, wherein generating a security key comprises applying a transformation to the initial key.

3. The method of claim 2, wherein the transformation comprises a concatenation, a randomization, a permutation, or combinations thereof.

4. The method of claim 1, wherein generating a security key comprises providing the initial key as input to a sequence generator.

5. The method of claim 4, wherein the providing comprises shifting the initial key into the sequence generator.

6. The method of claim 4, wherein the sequence generator comprises a pseudo-random binary sequence generator.

7. The method of claim 6, wherein the pseudo-random binary sequence generator comprises a sequence of memory cells.

8. The method of claim 7, wherein the pseudo-random binary sequence generator further comprises a logic circuit having at least two inputs coupled to memory cells in the sequence of memory cells and an output coupled to an input of the sequence of memory cells.

9. The method of claim 7, wherein the sequence of memory cells comprises M memory cells and the initial key comprises N bits, where M and N are positive integer values and M is at least equal to N.

10. The method of claim 4, wherein the sequence generator comprises a shift register.

11. The method of claim 1, wherein the security key comprises a binary sequence, and wherein applying the security key comprises applying the security key to the radio resource allocation information using a binary function.

12. The method of claim 11, wherein the binary function comprises a binary exclusive-OR function.

13. A method for device operations, the method comprises:
determining an initial key;
generating a security key from the initial key;
receiving secured information;
producing radio resource allocation information from the secured information by applying the security key to the secured information, wherein the radio resource allocation information comprises a location of radio resource allocated to a communications device; and
detecting for a transmission at network resources specified by the radio resource allocation information.

14. The method of claim 13, wherein determining an initial key comprises receiving the initial key.

15. The method of claim 13, wherein determining an initial key comprises producing the initial key.

16. The method of claim 13, wherein generating a security key comprises providing the initial key as input to a sequence generator.

17. The method of claim 16, wherein the sequence generator comprises a pseudo-random binary sequence generator.

18. The method of claim 13, wherein the security key comprises a binary sequence, and wherein applying the security key comprises applying the security key to the radio resource allocation information using a binary function.

19. The method of claim 18, wherein the binary function comprises a binary exclusive-OR function.

20. A communications controller comprising:
a key generator configured to generate a security key from an initial key;
a radio resource allocate unit configured to allocate a radio resource to a communications device, thereby producing radio resource allocation information;
an encryption unit coupled to the key generator and to the radio resource allocate unit, the encryption unit configured to apply the security key to the radio resource allocation information to produce encrypted radio resource allocation information; and
a transmitter coupled to the encryption unit, the transmitter configured to transmit the encrypted radio resource allocation information to the communications device.

21. The communications controller of claim 20, wherein the key generator comprises a pseudo-random binary sequence generator.

22. The communications controller of claim 21, wherein the pseudo-random binary sequence generator comprises:
a plurality of sequentially arranged memory cells having an input coupled to a signal input; and
a logic circuit having at least two inputs coupled to different memory cells in the plurality of memory cells and an output coupled to the input of the plurality of sequentially arranged memory cells, the logic circuit configured to apply a logical function to the at least two inputs.

23. The communications controller of claim 22, wherein the logical function comprises a binary bitwise exclusive-OR function.

24. The communications controller of claim 20, wherein the security key comprises a sequence, and wherein the encryption unit comprises a binary bitwise exclusive-OR unit applying the security key to the radio resource allocation information.
